(19) United States
(12) Patent Application Publication
(10) Pub. No.: US 2015/0168603 A1
(43) Pub. Date: Jun. 18, 2015

(54) LIGHT-REFLECTING COMPONENT AND METHOD FOR PRODUCING SAME

(71) Applicant: POLYPLASTICS CO., LTD., Tokyo (JP)

(72) Inventor: Fumiyuki Ohtake, Shizuoka (JP)

(73) Assignee: POLYPLASTICS CO., LTD., Tokyo (JP)

(21) Appl. No.: 14/409,297

(22) PCT Filed: Nov. 28, 2012
(86) PCT No.: PCT/JP2012/080684

§ 371 Date: Dec. 18, 2014

(30) Foreign Application Priority Data
Jun. 26, 2012 (JP) 2012-142925

(51) Int. Cl. G02B 1/04; B29C 45/00

(52) U.S. Cl. CPC G02B 1/04; B29C 45/0001; B29K 2085/00

(57) ABSTRACT

Provided are: a light-reflecting component which has excellent continuous moldability, heat resistance and surface properties (low diffuse reflectance); and a method for producing the light-reflecting component. A method for producing a light-reflecting component, the method comprising a step of injection-molding a resin composition obtained by melting and kneading a mixture containing 100 parts by mass of (A) a polyarylene sulfide resin, 10 to 120 parts by mass of (B1) a fibrous inorganic filler having a fiber length of 1 to 5 mm and 10 to 220 parts by mass of (C) a particulate filler using a mold in which a cavity surface is subjected to a surface treatment to be coated by a diamond-like carbon coating film.

### TECHNICAL FIELD

The present invention relates to a light-reflecting component required to have heat resistance and surface properties (low diffuse reflectance) and disposed behind a light source to reflect light from the light source and guide the light forward, and a method for producing the light-reflecting component, and particularly to a light-reflecting component such as a lamp reflector used for head lamps of vehicles such as automobiles, trucks and motorcycles, or a reflection member used for lighting fixtures, and a method for producing the light-reflecting component.

### BACKGROUND ART

Light-reflecting components such as lamp reflectors used for head lamps of vehicles such as automobiles, trucks and motorcycles, and reflection members used for lighting fixtures were composed mainly of metal materials in the past, but in recent years, resin materials having excellent continuous moldability have come into use for reduction of weight and diversification of designs. Examples of performance required as a material of a light-reflecting component include, in addition to sufficient mechanical strength and dimensional stability, heat resistance for enduring a high temperature during lighting of a light source, and surface properties (low diffuse reflectance) for reflecting light from a light source and guiding the light forward. Various resin compositions that can satisfy the above-described requirements and are used for molding of a light-reflecting component have been proposed. Among them, a polyarylene sulfide resin (hereinafter, referred to as a “PAS resin” in some cases) has excellent heat resistance, and is therefore suitable as a resin for light-reflecting components. Studies have been conducted for obtaining good surface properties as a light-reflecting surface in a light-reflecting component obtained using a resin composition containing a PAS resin (see, for example, Patent Literatures 1 and 2).

Patent Literature 1 discloses a lamp reflector including a lamp reflector main body and an aluminum-deposited layer, wherein a polyphenylene sulfide resin, and the like containing an inorganic filling material is used as a thermoplastic resin that forms the lamp reflector main body, and a part of the lamp reflector main body which is in contact with the aluminum-deposited layer is a surface molded by a mold polished to a surface roughness Ry of 0.1 μm or less. Particularly, it is disclosed that a lamp reflector having excellent surface properties (smoothness) and excellent rigidity can be obtained by blending a polyphenylene sulfide resin, mica or a potassium titanate whisker as an inorganic filler, and calcium carbonate having a predetermined particle size, each in a predetermined amount.

Patent Literature 2 discloses a lamp reflector (lamp reflecting mirror) obtained by injection-molding a composition containing a polyphenylene sulfide resin, a calcium silicate whisker and a particulate inorganic filler each in a predetermined amount. The lamp reflector has improved surface smoothness, so that a reflecting mirror can be formed even when a molded article is not coated with an undercoat layer but provided directly with a metal coating film.

In injection molding, maintenance such as mold change is absolutely necessary because surface properties are deteriorated, for example clouding occurs on the surface of a molded article due to contamination and degradation by sticking of a gas and a resin to a mold which is associated with continuous molding. It is preferred that such maintenance is minimized from the viewpoint of production costs and production efficiency. In other words, it is preferred that occurrence of clouding and the like on the surface of a molded article is low even when continuous molding is continued.

In Patent Literatures 1 and 2, deterioration of the surface properties of a molded article which is associated with continuous molding as described above is not considered.

On the other hand, Patent Literature 3 discloses a molding method in which a resin molding mold having a diamond-like carbon coating film on a surface thereof and having a predetermined surface roughness/surface impression is used for the purpose of giving an excellent glossiness and outer appearance to a resin molded article and performing molding with good mold releasability, and the mold is filled with a resin while a predetermined relationship is kept between the melting point of a crystalline resin (e.g., polyphenylene sulfide, polybutylene terephthalate or the like) and the mold temperature.

According to the molding method described in Patent Literature 3, the surface properties of a molded article and mold releasability from a mold can be improved, but for the surface properties, improvement of surface properties immediately after molding, i.e., in the initial stage, is persistently pursued. Patent Literature 3 describes that the method is effective for molding, particularly continuous molding, of a light-reflecting component such as a lamp reflector, but it is decided that “continuous molding is possible” here based on whether release from a mold is possible or not. That is, deterioration of the surface properties of a molded article which is associated with continuous molding as described above is not considered. In addition, it cannot be said that continuous molding is possible while surface properties fine enough for the surface to have a low diffuse reflectance are maintained.

### CITATION LIST

### Patent Literatures

Patent Literature 1: JP 2000-75112 A

Patent Literature 2: JP 9-251806 A

Patent Literature 3: JP 2005-342922 A

### SUMMARY OF INVENTION

### Technical Problem

The present invention has been devised in view of the above-described conventional problems, and an object of the present invention is to provide a light-reflecting component having excellent continuous moldability, heat resistance and surface properties (low diffuse reflectance), and a method for producing the light-reflecting component.

### Solution to Problem

The present invention for solving the above-mentioned problems is as follows.

(1) A method for producing a light-reflecting component, the method including a step of injection-molding a resin composition obtained by melting and kneading a mixture containing 100 parts by mass of (A) a polyarylene sulfide resin, 10 to 120 parts by mass of (B1) a fibrous inorganic filler having a fiber length of 1 to 5 mm and 10 to 220 parts by mass of (C) a particulate filler using a mold in which a cavity surface is subjected to a surface treatment to be coated by a diamond-like carbon coating film.

(2) A method for producing a light-reflecting component, the method including a step of injection-molding a resin composition obtained by melting and kneading a mixture containing 100 parts by mass of (A) a polyarylene sulfide resin, 30 to 150 parts by mass of (B2) a whisker-like inorganic filler having a fiber length of 30 μm or more and less than 1000 μm and 10 to 220 parts by mass of (C) a particulate filler using a mold in which a cavity surface is subjected to a surface treatment to be coated by a diamond-like carbon coating film.

(3) A method for producing a light-reflecting component, the method including a step of injection-molding a resin composition obtained by melting and kneading a mixture containing 100 parts by mass of (A) a polyarylene sulfide resin, X parts by mass of (B2a) a whisker-like inorganic filler having a fiber length of 2 μm or more and less than 30 μm, Y parts by mass of (B2b) a whisker-like inorganic filler having a fiber length of 100 μm or more and less than 1000 μm and a fiber diameter of 5 to 50 μm and 10 to 220 parts by mass of (C) a particulate filler using a mold in which a cavity surface is subjected to a surface treatment to be coated by a diamond-like carbon coating film, the resin composition satisfying all of the following formulae (1) to (3):

4/3<X/Y≦4 formula (1)

13≦Y<30 formula (2)

50≦X+Y≦150 formula (3).

(4) The method for producing a light-reflecting component according to (1), wherein the mixture is a mixture containing 100 parts by mass of (A) a polyarylene sulfide resin, 20 to 40 parts by mass of (B1) a fibrous inorganic filler having a fiber length of 1 to 3 mm and a fiber diameter of 3 to 7 μm and 10 to 220 parts by mass of (C) a particulate filler.

(5) The method for producing a light-reflecting component according to (2), wherein the mixture is a mixture containing 100 parts by mass of (A) a polyarylene sulfide resin, 50 to 80 parts by mass of (B2) a whisker-like inorganic filler having a fiber length of 30 to 150 μm and a fiber diameter of 2 to 10 μm and 10 to 220 parts by mass of (C) a particulate filler.

(6) The method for producing a light-reflecting component according to (3), wherein the mixture is a mixture containing 100 parts by mass of (A) a polyarylene sulfide resin, X parts by mass of (B2a) a whisker-like inorganic filler having a fiber length of 2 μm or more and less than 30 μm and a fiber diameter of 2 to 10 μm, Y parts by mass of (B2b) a whisker-like inorganic filler having a fiber length of 100 to 150 μm and a fiber diameter of 5 to 10 μm and 10 to 220 parts by mass of (C) a particulate filler, the resin composition satisfying all of the following formulae (1) to (3′):

4/3<X/Y≦4 formula (1)

13≦Y<30 formula (2)

50≦X+Y≦80 formula (3′).

(7) The method for producing a light-reflecting component according to any of (1) to (6), wherein the mixture is a mixture further containing (D) a lubricant.

(8) The method for producing a light-reflecting component according to (7), wherein a polyethylene wax having no acid value is used as the (D) lubricant.

(b 9) The method for producing a light-reflecting component according to (5), wherein the mixture is a mixture which contains, as the (C) particulate filler, 50 to 110 parts by mass of a particulate filler having an average particle diameter (50% d) of 1.5 μm or less as measured by a laser diffraction/scattering method, and further contains 0.1 to 2 parts by mass of (D) a polyethylene wax having no acid value.

(10) The method for producing a light-reflecting component according to (6), wherein the mixture is a mixture which contains, as the (C) particulate filler, 50 to 110 parts by mass of a particulate filler having an average particle diameter (50% d) of 1.5 μm or less as measured by a laser diffraction/scattering method, and further contains 0.1 to 2 parts by mass of (D) a polyethylene wax having no acid value.

(11) The method for producing a light-reflecting component according to any of (1) to (10), wherein the mixture is a mixture further containing (E) a silane compound.

(12) The method for producing a light-reflecting component according to any of (1) to (11), wherein the pressure keeping force during injection molding is 50 to 70 MPa.

(13) The method for producing a light-reflecting component according to any of (1) to (12), wherein the pressure keeping speed during injection molding is 50 to 150 mm/sec.

(14) A light-reflecting component produced by the method for producing a light-reflecting component according to any of (1) to (13).

### Advantageous Effects of Invention

According to the present invention, there can be provided a light-reflecting component having excellent continuous moldability, heat resistance and surface properties (low diffuse reflectance), and a method for producing the light-reflecting component.

### DESCRIPTION OF EMBODIMENTS

<Method for Producing Light-Reflecting Component>

A method for producing a light-reflecting component according to a first aspect of the present invention includes a step of injection-molding a resin composition obtained by melting and kneading a mixture containing 100 parts by mass of (A) a polyarylene sulfide resin, 10 to 120 parts by mass of (B1) a fibrous inorganic filler having a fiber length of 1 to 5 mm and 10 to 220 parts by mass of (C) a particulate filler using a mold in which a cavity surface is subjected to a surface treatment to be coated by a diamond-like carbon coating film.

A method for producing a light-reflecting component according to a second aspect of the present invention includes a step of injection-molding a resin composition obtained by melting and kneading a mixture containing 100 parts by mass of (A) a polyarylene sulfide resin, 30 to 150 parts by mass of (B2) a whisker-like inorganic filler having a fiber length of 30 μm or more and less than 1000 μm and 10 to 220 parts by mass of (C) a particulate filler using a mold in which a cavity surface is subjected to a surface treatment to be coated by a diamond-like carbon coating film.

Further, a method for producing a light-reflecting component according to a third aspect of the present invention includes a step of injection-molding a resin composition obtained by melting and kneading a mixture containing 100 parts by mass of (A) a polyarylene sulfide resin, X parts by mass of (B2a) a whisker-like inorganic filler having a fiber length of 2 μm or more and less than 30 μm, Y parts by mass of (B2b) a whisker-like inorganic filler having a fiber length of 100 μm or more and less than 1000 μm and a fiber diameter of 5 to 50 μm and 10 to 220 parts by mass of (C) a particulate filler using a mold in which a cavity surface is subjected to a surface treatment to be coated by a diamond-like carbon coating film, the resin composition satisfying all of the following formulae (1) to (3):

4/3<X/Y≦4 formula (1)

13≦Y<30 formula (2)

50≦X+Y≦150 formula (3).

In any of the aspects, the method for producing a light-reflecting component according to the present invention can produce a light-reflecting component having excellent heat resistance and surface properties (low diffuse reflectance) required for the light-reflecting component by injection-molding the above-mentioned resin composition using the predetermined mold. Further, the method has such excellent continuous moldability that continuous molding is possible while the above-mentioned properties are maintained. Here, the “continuous moldability” in the present invention refers to an ability to perform molding continuously without causing clouding and the like to occur on the surface of a molded article.

First, respective components of the resin composition (mixture) to be used for the production method of the present invention will be described in detail below.

[(A) Polyarylene Sulfide Resin]

The polyarylene sulfide resin as the (A) resin component is a polymer compound principally including —(Ar—S)— (where Ar is an arylene group) as a repeating unit, and in the present invention, a PAS resin having a generally known molecular structure can be used.

Examples of the arylene group include a p-phenylene group, a m-phenylene group, an o-phenylene group, a substituted phenylene group, a p,p′-diphenylene sulfone group, a p,p′-biphenylene group, a p,p′-diphenylene ether group, a p,p′-diphenylene carbonyl group and a naphthalene group. The PAS resin may a homopolymer including only the repeating unit described above, or the following copolymer including different types of repeating unit may be preferred from the viewpoint of processability.

As a homopolymer, a polyphenylene sulfide resin (hereinafter, also referred to as a “PPS resin”) having a p-phenylene sulfide resin as a repeating unit with a p-phenylene group used as an arylene group is preferably used. As a copolymer, a combination of two or more different types among arylene sulfide groups including the arylene groups can be used, and particularly combinations including p-phenylene sulfide groups and m-phenylene sulfide groups are especially preferably used. Among them, combinations including 70 mol % or more, preferably 80 mol % or more of p-phenylene sulfide groups are suitable from the viewpoint of physical properties such as heat resistance, moldability and mechanical properties. Among these PAS resins, high-molecular-weight polymers of substantially linear structure which are obtained by condensation polymerization from a monomer principally including a difunctional halogen aromatic compound are especially preferably used. For the (A) PAS resin to be used in the present invention, two or more PAS resins having different molecular weights may be mixed and used.

Examples of the (A) resin component include, in addition to PAS resins of linear structure, polymers in which a branch structure or a crosslinked structure is partially formed using a small amount of a monomer such as a polyhalogenated aromatic compound having three or more halogen substituents when condensation polymerization is performed, and polymers with molding processability improved by heating a low-molecular-weight polymer of linear structure at a high temperature in the presence of oxygen or the like to increase a melt viscosity by oxidative crosslinking or thermal crosslinking. Particularly, a polymer in which a branch structure or a crosslinked structure is formed is suitable for continuous molding because it is solidified more quickly as compared to a polymer of linear structure.

The melt viscosity (310° C./shear velocity: 1216 sec⁻¹) of the PAS resin as a base resin to be used in the present invention is preferably 600 Pa·s or less including the case of the mixed system described above, and particularly a melt viscosity in a range of 8 to 300 Pa·s is especially preferred because a balance between mechanical properties and fluidity is excellent. When the melt viscosity is more than 600 Pa·s, it becomes difficult to improve surface properties, so that defects may occur.

[(B1) Fibrous Inorganic Filler and (B2) Whisker-Like Inorganic Filler]

In the present invention, for improving mechanical strength, the (B1) fibrous inorganic filler is blended in the first aspect, and the (B2) whisker-like inorganic filler is blended in the second and third aspects. Here, both the fibrous inorganic filler and the whisker-like inorganic filler are in the shape of a fiber, but in the present invention, the “inorganic filler having a length of 1 mm or more” with a fibrous shape is a “fibrous inorganic filler”, and the “inorganic filler having a length less than 1 mm” is a “whisker-like inorganic filler”.

Hereinafter, the (B1) fibrous inorganic filler and the (B2) whisker-like inorganic filler will be described in succession.

((B1) Fibrous Inorganic Filler)

As described above, in the first aspect, the (B1) fibrous inorganic filler is blended, and examples of the fibrous inorganic filler that can be used in the present invention include glass fibers, silica fibers, and metallic fibrous materials such as those of stainless steel, aluminum, titanium, copper and brass. Among them, glass fibers are preferred. They may be used alone, or may be used in combination of two or more thereof.

The fiber length of the fibrous inorganic filler is preferably 1 to 5 mm, more preferably 1 to 3 mm from the viewpoint of strength, heat resistance, surface properties (low diffuse reflectance) and toughness. When the fiber length is more than 5 mm, surface properties (low diffuse reflectance) are deteriorated.

The fiber diameter of the fibrous inorganic filler is preferably 14 μm or less, more preferably 3 to 7 μm from the viewpoint of improvement of surface properties (low diffuse reflectance).

In the first aspect, the (B1) fibrous inorganic filler is blended in an amount of 10 to 120 parts by mass based on 100 parts by mass of the (A) PAS resin in preparation of a mixture that is melted and kneaded to obtain a resin composition. When the blending amount is less than 10 parts by mass, strength and heat resistance are deteriorated, and when the blending amount is more than 120 parts by mass, surface properties (low diffuse reflectance) are deteriorated, and toughness is reduced. The blending amount of the (B1) fibrous inorganic filler is preferably 20 to 40 parts by mass. When the blending amount is 20 to 40 parts by mass, surface properties (low diffuse reflectance) are further improved.

((B2) Whisker-Like Inorganic Filler)

As described above, in the second and third aspects, the (B2) whisker-like inorganic filler is blended, and examples of the whisker-like inorganic filler that can be used in the present invention include wollastonite, asbestos fibers, alumina fibers, zirconia fibers, boron nitride fibers, silicon nitride fibers, boron fibers and potassium titanate fibers. Among them, wollastonite is preferred. They may be used alone, or may be used in combination of two or more thereof.

On the other hand, the (B2) whisker-like inorganic filler having a fiber length of 30 μm or more and less than 1000 μm is used in the second aspect, and the (B2a) whisker-like inorganic filler having a fiber length of 2 μm or more and less than 30 μm and the (B2b) whisker-like inorganic filler having a fiber length of 100 μm or more and less than 1000 μm and a fiber diameter of 5 to 50 μm are used in combination in the third aspect.

As described above, in the second aspect, a whisker-like inorganic filler having a fiber length of 30 μm or more and less than 1000 μm, and when one having a fiber length within this range is used, a light-reflecting component excellent in strength, heat resistance, surface properties (low diffuse reflectance) and toughness is obtained. The fiber length is preferably 30 to 600 μm, more preferably 30 to 150 μm.

The fiber diameter of the (B2) whisker-like inorganic filler is preferably 50 μm or less, more preferably 2 to 40 μm, further preferably 2 to 10 μm.

In the second aspect, the (B2) whisker-like inorganic filler is blended in an amount of 30 to 150 parts by mass based on 100 parts by mass of the (A) PAS resin in preparation of a mixture that is melted and kneaded to obtain a resin composition. When the blending amount is less than 30 parts by mass, strength and heat resistance are deteriorated, and when the blending amount is more than 150 parts by mass, surface properties (low diffuse reflectance) are deteriorated, and toughness is reduced. The blending amount of the (B2) whisker-like inorganic filler is preferably 50 to 80 parts by mass. When the blending amount is 50 to 80 parts by mass, surface properties (low diffuse reflectance) are further improved.

In the second aspect, as long as the total blending amount of whisker-like inorganic filler components falls within a range of 30 to 150 parts by mass, a whisker-like inorganic filler having a fiber length different from the fiber length of each of the whisker-like inorganic fillers (B2a) and (B2b) in the third aspect may be used in combination in addition to a whisker-like inorganic filler having the above-mentioned fiber length within the bounds of not impairing the effect of the present invention.

In the second aspect, as the (B2) whisker-like inorganic filler, a whisker-like inorganic filler having a single fiber length may be used, or whisker-like inorganic fillers having different fiber lengths may be used in combination as long as the fiber length falls within a range of 30 μm or more and less than 1000 μm.

On the other hand, in the third aspect, the (B2a) whisker-like inorganic filler having a fiber length of 2 μm or more and less than 30 μm and the (B2b) whisker-like inorganic filler having a fiber length of 100 μm or more and less than 1000 μm and a fiber diameter of 5 to 50 μm are used in combination.

In the (B2a) whisker-like inorganic filler, the fiber length is 2 μm or more and less than 30 μm, and in particular, preferably 2 to 10 μm. When the fiber length is 2 μm or more and less than 30 μm, a light-reflecting component having excellent surface properties (low diffuse reflectance) and excellent continuous moldability is obtained. In the (B2a) whisker-like inorganic filler, the fiber diameter is preferably 2 to 10 μm, more preferably 2 to 5 μm.

In the (B2b) whisker-like inorganic filler, the fiber length is 100 μm or more and less than 1000 μm, and the fiber diameter is 5 to 50 μm. The fiber length is preferably 100 to 600 μm, more preferably 100 to 150 μm. When the fiber length is 100 μm or more and less than 1000 μm, a light-reflecting component having excellent heat resistance is obtained. The fiber diameter is preferably 5 to 10 μm. When the fiber diameter is 5 to 50 μm, a light-reflecting component having excellent heat resistance because the filler is hard to be broken, and has a fiber length necessary for exhibiting an effect after melting and kneading.

On the other hand, in the third aspect, the (B2a) and (B2b) whisker-like inorganic fillers are blended in an amount of X and Y parts by mass, respectively, in preparation of a mixture that is melted and kneaded to obtain a resin composition. Here, the whisker-like inorganic fillers are blended so that X and Y satisfy all of the following formulae (1) to (3):

4/3<X/Y≦4 formula (1)

13≦Y<30 formula (2)

50≦X+Y≦150 formula (3).

The formula (1) is a formula that defines a blending ratio of the (B2a) and (B2b) whisker-like inorganic fillers. When the formula (1) is satisfied, a light-reflecting component excellent in surface properties (low diffuse reflectance), continuous moldability and heat resistance is obtained. The heat resistance of the obtained light-reflecting component is improved as X/Y becomes closer to 4/3 (lower limit) in the formula (1). On the other hand, the surface properties (low diffuse reflectance) and continuous moldability of the obtained light-reflecting component are improved as X/Y becomes closer to 4 (upper limit). Since the light-reflecting component to be produced by the production method of the present invention is required to have higher surface properties (low diffuse reflectance), X/Y is preferably 2.5 to 4, more preferably 3 to 4.

The formula (2) is a formula that defines only a blending amount of the (B2b) component. When the blending amount is 13 parts by mass or more and less than 30 parts by mass, a light-reflecting component having excellent surface properties (low diffuse reflectance) and excellent heat resistance is obtained.

The formula (3) is a formula that defines a total blending amount of the (B2a) and (B2b) respective whisker-like inorganic fillers. That is, the formula shows that the total amount of the (B2a) and (B2b) respective whisker-like inorganic fillers is 50 to 150 parts by mass. When the total blending amount is less than 50 parts by mass, strength and heat resistance are deteriorated, and when the blending amount is more than 150 parts by mass, surface properties (low diffuse reflectance) are deteriorated, and toughness is reduced. The total blending amount is preferably 50 to 80 parts by mass (formula (3′)). When the blending amount is 50 to 80 parts by mass, surface properties (low diffuse reflectance) are further improved.

[(C) Particulate Filler]

In the present invention, the (C) particulate filler is blended for suppressing sinking. Examples of the (C) particulate filler include calcium carbonate, silica, synthetic silica, kaolin, hollow glass beads, barium sulfate, barium carbonate, titanium oxide, zinc oxide, aluminum oxide, talk, clay, argil, china clay, silica sand, silica stone and diatomaceous earth, and particularly, calcium carbonate, silica, synthetic silica, kaolin, hollow glass beads and barium sulfate are preferred. They may be used alone, or may be used in combination of two or more thereof.

The average particle size (50% d) of the (C) particulate filler as measured by a laser diffraction/scattering method, is preferably 5.0 μm or less, more preferably 2.0 μm or less, further preferably 1.5 μm or less.

In the present invention, for effectively suppressing sinking, the (C) particulate filler is blended in an amount of 10 to 220 parts by mass, preferably 50 to 110 parts by mass based on 100 parts by mass of the (A) PAS resin in preparation of a mixture that is melted and kneaded to obtain a resin composition. By suppressing sinking, the diffuse reflectance can be reduced.

When the average particle size (50% d) of the (C) particulate filler as measured by a laser diffraction/scattering method is 1.5 μm or less, and the resin composition has such a composition that the blending amount of the (C) particulate filler is 50 to 110 parts by mass based on 100 parts by mass of the (A) PAS resin, particularly surface properties (low diffuse reflectance) are extremely improved, so that a light-reflecting surface (mirror surface) can be provided by directly depositing a metal on a light-reflecting region of a molded article without forming an undercoat layer for improvement of surface smoothness.

[(D) Lubricant]

In the present invention, it is preferred to blend the (D) lubricant for improving moldability, mold releasability and measurement stability. The type of the (D) lubricant is not particularly limited, and for example, polyethylene waxes, pentaerythritol stearic acid esters, montanic acid esters, ethylene-bis-stearic acid amides, and the like are preferred. Particularly, it is preferred to use a polyethylene wax having no oxidation. This is because while a polyethylene wax has excellent oxidation resistance, and is not degraded in molding, particularly a polyethylene wax having an acid value of 0 has no polarity, and therefore is not compatible with a PAS resin having polarity, and hence functions as an effective mold releasing agent. Consequently, when a polyethylene wax having no acid value is used, a light-reflecting component excellent in continuous moldability is obtained.

For example, the acid value of polyethylene wax means a number of milligrams of potassium hydroxide necessary for neutralizing 1 g of polyethylene wax.

In the present invention, for further improving moldability, mold releasability and measurement stability, the (D) lubricant is blended in an amount of preferably 0.1 to 2 parts by mass, more preferably 0.2 to 2 parts by mass, further preferably 0.5 to 1 part based on 100 parts by mass of the (A) PAS resin in preparation of a mixture that is melted and kneaded to obtain a resin composition.

[(E) Silane Compound]

In the present invention, it is preferred to blend the (E) silane compound for further improving continuous moldability. The silane compound is not particularly limited, examples thereof include alkoxysilanes such as epoxyalkoxysilanes, aminoalkoxysilanes, vinylalkoxysilanes and mercaptoalkoxysilanes, and one or two or more thereof are used. The carbon number of alkoxy group is preferably 1 to 10, especially preferably 1 to 4.

Examples of the epoxyalkoxysilane include γ-glycidoxypropyltrimethoxysilane, β-(3,4-epoxycyclohexyl)ethyltrimethoxysilane, γ-glycidoxypropyltriethoxysilane, and the like.

Examples of aminoalkoxysilane include γ-aminopropyltrimethoxysilane, γ-aminopropyltriethoxysilane, γ-aminopropylmethyldimethoxysilane, γ-aminopropylmethyldiethoxysilane, N-(β-aminoethyl)-γ-aminopropyltrimethoxysilane, N-phenyl-γ-aminopropyltrimethoxysilane, γ-diallylaminopropyltrimethoxysilane, γ-diallylaminopropyltriethoxysilane, and the like.

Examples of the vinylalkoxysilane include vinyltrimethoxysilane, vinyltriethoxysilane, vinyltris(β-methoxyethoxy)silane, and the like.

Examples of the mercaptoalkoxysilane include γ-mercaptopropyltrimethoxysilane, γ-mercaptopropyltriethoxysilane, and the like.

Among them, the epoxyalkoxysilane and the aminoalkoxysilane are preferred, with γ-aminopropyltriethoxysilane being especially preferred.

In the present invention, the (C) silane compound is blended in an amount of preferably 0.1 to 2 parts by mass, more preferably 0.5 to 1.5 parts by mass based on 100 parts by mass of the (A) PAS resin in preparation of a mixture that is melted and kneaded to obtain a resin composition.

[Other Components]

In the present invention, a nucleating agent, a crosslinked PPS resin, COC, and the like may be blended in addition to the components described above. Particularly, by blending a nucleating agent and a crosslinked PPS resin, solidification can be quickened, so that more satisfactory surface properties are obtained.

In the method for producing a light-reflecting component according to the present invention, a resin composition obtained by melting and kneading the above-mentioned mixture is injection-molded using a mold, in which a cavity surface is subjected to a surface treatment to be coated by a diamond-like carbon coating film, to produce a light-reflecting component. Specifically, the resin composition is introduced into an extruder, and melted and kneaded to be formed into a pellet, and the pellet is introduced into an injection molding machine equipped with the mold, and injection-molded to produce a light-reflecting component. Since diamond-like carbon is amorphous, it is possible to perform a surface treatment to give an excellent mirror surface property which cannot be achieved by a metal such as, for example, TiN, or the like. Since diamond-like carbon has a very low friction coefficient, a resin is not stuck to a mold, and therefore mold releasability is further improved. The cavity refers to the whole of a space in a mold which is filled with a resin.

The diamond-like carbon coating film in the mold is formed on the cavity surface of a mold base by the technique described in JP 10-203896 A and JP 63-185893 A. The film thickness of the diamond-like carbon coating film is 0.5 to 3.0 μm.

The material of the mold base is not particularly limited, and examples thereof include stainless steel such as SUS 420J2, alloy tool steel such as SKD 11, SKD 12, SKD 61 and SK 3, high-speed steel such as SKH 151, structural carbon steel such S 55C and SCM 440, and non-ferrous alloys such as aluminum alloys and beryllium-copper.

The surface hardness and surface roughness of the mold base are not particularly limited, but it is preferred to increase the surface hardness or reduce the surface roughness to some extent.

For strengthening bonding between the metal base and the diamond-like carbon coating film, the surface of the mold base may be treated to provide various kinds of intermediate layers.

On the other hand, when the pressure keeping force and/or the pressure keeping speed fall within the range described below during injection molding, occurrence of sinking and burr can be suppressed, so that transfer properties can be improved to further improve surface properties (low diffuse reflectance). Among them, the pressure keeping speed has an higher effect in particular.

The pressure keeping force during injection molding is preferably 30 to 100 MPa, more preferably 50 to 70 MPa.

The pressure keeping speed during injection molding is preferably 50 to 200 mm/sec, more preferably 100 to 150 mm/sec.

<Light-Reflecting Component>

The light-reflecting component of the present invention is produced by the foregoing method for producing a light-reflecting component according to the present invention. That is, the light reflecting component of the present invention is obtained by the foregoing production method, and therefore has excellent surface properties (low diffuse reflectance) and heat resistance.

### EXAMPLES

The present invention will be described further in detail below by way of examples, but the present invention is not limited to examples below.

### Examples 1 to 22 and Comparative Examples 1 to 7

In each of examples and comparative examples, a mixture obtained by dry-blending the raw material components shown in Table 1 was introduced into a twin screw extruder with a cylinder temperature of 320° C. (wollastonite, glass fibers and hollow glass beads were separately added from a side feed section of the extruder), melted and mixed to be formed into a pellet.

Details of the respective raw material components used are shown below.

(A) Component (PAS Resin)

Total two PPS resins: any of the following (a), (c) and (d) PPS resins and the following (b) PPS resin C were mixed and used.

(a) PPS resin A: Fortron KPS manufactured by KUREHA CORPORATION (melt viscosity: 9 Pa·s (shear velocity: 1216 sec⁻¹, 310° C.)).

A method for synthesizing the PPS resin A is shown below.

5700 g of NMP (N-methyl-2-pyrrolidone) was added in a 20 L autoclave, replaced with a nitrogen gas, and then heated to 100° C. for 1 hour while being stirred by a stirrer at a rotation number of 250 rpm. After the temperature reached 100° C., 1170 g of an aqueous solution of NaOH at a concentration of 74.7% by mass, 1990 g of an aqueous solution of sulfur source (including NaSH=21.8 mol and Na₂S=0.50 mol) and 1000 g of NMP were added, the mixture was gradually heated to 200° C. for about 2 hours, and 945 g of water, 1590 g of NMP and 0.31 mol of hydrogen sulfide were discharged to outside the system.

After the dehydration step, the mixture was cooled to 170° C., 3524 g of p-DCB (p-dichlorobenzene), 2800 g of NMP, 133 g of water and 23 g of NaOH at a concentration of 97% by weight were added, so that the temperature in the vessel became 130° C. Subsequently, the mixture was heated to 180° C. for 30 minutes, and further heated from 180° C. to 220° C. for 60 minutes while being stirred by the stirrer at a rotation number of 250 rpm. The mixture was reacted at this temperature for 60 minutes, then heated to 230° C. for 30 minutes, and reacted at 230° C. for 90 minutes to perform pre-stage polymerization.

After completion of pre-stage polymerization, the rotation number of the stirrer was immediately increased to 400 rpm, and 340 g of water was pressed into the vessel. After pressing water, the mixture was heated to 260° C. for 1 hour, and reacted at this temperature for 5 hours to perform post-stage polymerization. After completion of post-stage polymerization, the reaction mixture was cooled to around a room temperature, the contents were then made to pass over a 100-mesh screen to sieve out a particulate polymer, and the particulate polymer was then washed with acetone three times, with water three times, with 0.3% acetic acid, and then with water four times to obtain a washed particulate polymer. The particulate polymer was dried at 105° C. for 13 hours. The particulate polymer thus obtained had a melt viscosity of 10 Pa·s. This operation was repeated five times to obtain a required amount of a polymer (PPS resin A).

(b) PPS resin B: “Fortron (registered trademark) F 9020 black, color number: HD 9920 20% color concentrate” manufactured by Polyplastics Co., Ltd.).

(c) PPS resin C: Fortron KPS W202A manufactured by KUREHA CORPORATION (melt viscosity: 20 Pa·s (shear velocity: 1216 sec⁻¹, 310° C.)).

(d) PPS resin D: Fortron KPS W203A manufactured by KUREHA CORPORATION (melt viscosity: 30 Pa·s (shear velocity: 1216 sec⁻¹, 310° C.)).

The number of parts by mass of the (A) component shown in Tables 1 and 2 corresponds to the total amount of only PPS resin components in each PPS resin obtained by mixing two PPS resins.

(B1) Component (Fibrous Inorganic Filler) or (B2) Component (Whisker-Like Inorganic Filler)

Fibrous inorganic filler A: glass fibers (CS 03 DE FT523 manufactured by Owens Corning Japan LLC (fiber length: 3 mm; fiber diameter: 6.5 μm)).

Whisker-like inorganic filler A: wollastonite (NYAD 1250 manufactured by NYCO Minerals, Inc. (fiber length: 9 μm; fiber diameter: 3.5 μm)).

Whisker-like inorganic filler B: wollastonite (NYGLOS 8 manufactured by NYCO Minerals, Inc. (fiber length: 136 μm; fiber diameter: 8 μm)).

(C) Component (Particulate Filler)

Particulate filler A: calcium carbonate (Brilliant-1500 manufactured by SHIRAISHI KOGYO KAISHA, LTD. (average particle size 50% d: 0.7 μm)).

Particulate filler B: calcium carbonate (KS-1300 manufactured by CALFINE CO., LTD (average particle size 50% d: 3.0 μm)).

Particulate filler C: kaolin (TRANSLINK 445 manufactured by BASF Japan Ltd. (average particle size 50% d: 1.4 μm; surface-treated aluminum silicate (kaolin clay)).

Particulate filler D: hollow glass beads (ZEEOSPHERE 200 Grained Product manufactured by NIPPON COLOR Ind. Co., Ltd (average particle size 50% d: 4.0 μm)).

(D) Component (Lubricant)

Lubricant A: UNISTAR H476 manufactured by NOF CORPORATION.

Lubricant B: SANWAX 161-P manufactured by Sanyo Chemical Industries, Ltd.

Lubricant C: LICOWAX PED 191 manufactured by Clariant (Japan) K.K. (number average molecular weight: 5000, acid value: 17).

(E) Component (Silane Compound)

Silane compound: γ-aminopropyltriethoxysilane (KBE-903P manufactured by Shin-Etsu Chemical Co., Ltd.).

From the pellet prepared in the manner described above, various kinds of test pieces were prepared under the following molding conditions using an injection molding machine (J55AD manufactured by The Japan Steel Works, Ltd.) equipped with a mold in which a cavity surface is subjected to a surface treatment to be coated by a diamond-like carbon coating film, and the following evaluations were performed. In each comparative example, a mold that was not surface-treated was used. The results are shown in Table 1.

### (Molding Conditions)

Cylinder temperature (temperature on nozzle side to hopper side): (nozzle side) 320-320-320-320-310-290° C. (hopper side).

Mold temperature: 150° C.

Injection speed: 150 mm/sec.

Pressure keeping force: 50 MPa or 70 MPa.

Pressure keeping speed: 50 mm/sec or 150 mm/sec.

Injection+pressure keeping time: 15 sec, cooling time: 15 sec.

Screw rotation number: 100 rpm

On the other hand, the surface treatment of the mold cavity surface to be coated by the diamond-like carbon coating film was performed in the following manner.

The surface of a mold piece for a color plate, which was prepared by a mold steel material: HPM 38 (manufactured by Hitachi metals Tool Steel, Ltd.), was treated with DLC (Diamond Like Carbon; manufactured by Japan Coating Center Co., Ltd.; Jcoat Slick Coat-F; film thickness: 1.5 to 2.5 μm; hardness: 1500 to 2500 HV; friction coefficient: 0.05 to 0.10; oxidation temperature: 500° C.).

(1) Continuous Moldability

A color plate (test piece having a mirror surface on the mold fixing side) having a length of 65 mm, a width of 55 mm and a thickness of 2 mm (with a side gate having a width of 10 mm and a thickness of 2 mm) was prepared at a cylinder temperature of 320° C. and a mold temperature of 150° C. by injection molding. For the mirror surface of the test piece on the mold fixing side, presence/absence of clouding was evaluated by visual inspection, and a shot number at which clouding started to occur was measured.

(2) Deflection Temperature under Load (DTUL)—Heat Resistance—

A test piece (width: 10 mm and thickness: 4 mm) conforming to ISO 3167 was prepared at a cylinder temperature of 320° C. and a mold temperature of 150° C. was prepared by injection molding, and measured under the following conditions.

Measurement device: HD 500-PC; Heat Distortion Tester manufactured by Yasuda Seiki seisakusho LTD.

Air chamber type high-temperature DTUL.

Fixed-fixed beam/both end free end/center load.

Span: 64 mm.

Stress: 1.80 MPa.

Temperature: 2° C./min, start at 50° C.

(3) Diffuse Reflectance—Surface Properties—

A color plate (test piece having a mirror surface on the mold fixing side) having a length of 65 mm, a width of 55 mm and a thickness of 2 mm (with a side gate having a width of 10 mm and a thickness of 2 mm) was prepared at a cylinder temperature of 320° C. and a mold temperature of 150° C. by injection molding, aluminum was deposited on the mirror surface of the test piece on the mold fixing side, and the deposited surface was measured under the following conditions in accordance with ISO 7724/1.

Measurement device: SPECTROPHOTOMETER manufactured by TOYO SEIKI Co., Ltd.; color-sphere

Measurement area: φ30

Measurement wavelength: 400 nm

The deposition of aluminum was performed under the following conditions.

An aluminum wire was finely cut, and about 0.2 g thereof was placed on a W board (resistor), and the W board was placed on an electrode section. The inside of a test vessel was evacuated, and a current was made to pass through the W board to melt the aluminum wire placed on the W board, so that aluminum was formed into fine particles and scattered. The scattered aluminum was guided to the mirror surface of the test piece on the mold fixing side and deposited on the mirror surface. Devices, conditions, and the like that were used for deposition are shown below.

Test machine: AIF-850 SB Model Ion Plating Device manufactured by Shinko Seiki Co., Ltd.

Deposition method: resistance heating method.

W board: Vacom Standard Board BY-107 manufactured by Furuuchi Chemical Corporation.

Aluminum wire: Al Wire (ALM-11005A) manufactured by Furuuchi Chemical Corporation.

Vacuum degree: 10⁻³ Pa.

Rotation number of sample stage: 1000 rpm.

Current: 30 A.

Deposition time: 4 minutes.

(4) Melt Viscosity

Using CAPILOGRAPH manufactured by TOYO SEIKI Co., Ltd., a melt viscosity was measured at a barrel temperature of 310° C. and a shear velocity of 1216 sec⁻¹ using a 1 mmφ×20 mmL/flat die as a capillary.

TABLE 1

| | | Comparative | | Comparative | Comparative | | | |
|---|---|---|---|---|---|---|---|---|
| | | Example 1 | Example 1 | Example 2 | Example 3 | Example 2 | Example 3 | Example 4 |
| Mold surface treatment | Diamond like carbon | Done | Done | Not done | Done | Done | Done | Done |
| Molding conditions | Pressure keeping force (MPa) | 50 | 50 | 50 | 50 | 50 | 50 | 50 |
| | Pressure keeping speed (mm/s) | 50 | 50 | 50 | 50 | 50 | 50 | 50 |
| (A) Component | PPS resin A + PPS resin B | 100 | 100 | 100 | 100 | 100 | 100 | 100 |
| (parts by mass) | PPS resin C + PPS resin B | — | — | — | — | — | — | — |
| | PPS resin D + PPS resin B | — | — | — | — | — | — | — |
| (B) Component | Fibrous inorganic filler A | 25 | 26 | 26 | — | — | — | — |
| (parts by mass) | Whisker-like inorganic filler A | — | — | — | 51 | — | — | 51 |
| | Whisker-like inorganic filler B | — | — | — | — | 45 | 64 | 13 |
| (C) Component | Particulate filler A | — | 128 | 128 | 102 | — | — | — |
| (parts by mass) | Particulate filler B | — | — | — | — | 79 | 90 | 90 |
| | Particulate filler C | — | — | — | — | — | — | — |
| | Particulate filler D | — | — | — | — | — | — | — |
| (D) Component | Lubricant A | — | 0.51 | 0.51 | — | — | — | — |
| (parts by mass) | Lubricant B | 0.36 | — | — | 0.51 | 0.68 | 0.77 | 0.77 |
| | Lubricant C | — | — | — | — | — | — | — |
| (E) Component | Silane compound | 0.8 | 0.8 | 0.8 | 0.8 | 0.9 | 1.0 | 1.0 |
| (parts by mass) | | | | | | | | |

| | | | | | | | |
|---|---|---|---|---|---|---|---|
| Deflection temperature under load (DTUL (° C.)) | >270 | >270 | >270 | 185 | 245 | 245 | 203 |
| Continuous moldability (shot number at which clouding | 250 | 250 | 7 | >300 | >300 | >300 | >300 |
| started to occur on the mirror surface) | | | | | | | |
| Diffuse reflectance (% R), initial, 400 nm | 9.6 | 4.0 | 4.6 | 1.9 | 3.5 | 3.2 | 2.5 |

| | | | Comparative | | | | | Example |
|---|---|---|---|---|---|---|---|---|
| | | Example 5 | Example 4 | Example 6 | Example 7 | Example 8 | Example 9 | 10 |
| Mold surface treatment | Diamond like carbon | Done | Not done | Done | Done | Done | Done | Done |
| Molding conditions | Pressure keeping force (MPa) | 50 | 50 | 50 | 70 | 100 | 50 | 70 |
| | Pressure keeping speed (mm/s) | 50 | 50 | 50 | 50 | 50 | 150 | 150 |
| (A) Component | PPS resin A + PPS resin B | 100 | 100 | 100 | 100 | 100 | 100 | 100 |
| (parts by mass) | PPS resin C + PPS resin B | — | — | — | — | — | — | — |
| | PPS resin D + PPS resin B | — | — | — | — | — | — | — |
| (B) Component | Fibrous inorganic filler A | — | — | — | — | — | — | — |
| (parts by mass) | Whisker-like inorganic filler A | 51 | 51 | 51 | 51 | 51 | 51 | 51 |
| | Whisker-like inorganic filler B | 13 | 13 | 13 | 13 | 13 | 13 | 13 |
| (C) Component | Particulate filler A | 89 | 89 | 89 | 89 | 89 | 89 | 89 |
| (parts by mass) | Particulate filler B | — | — | — | — | — | — | — |
| | Particulate filler C | — | — | — | — | — | — | — |
| | Particulate filler D | — | — | — | — | — | — | — |
| (D) Component | Lubricant A | 0.51 | 0.51 | — | — | — | — | — |
| (parts by mass) | Lubricant B | — | — | 0.51 | 0.51 | 0.51 | 0.51 | 0.51 |
| | Lubricant C | — | — | — | — | — | — | — |
| (E) Component | Silane compound | 1.0 | 1.0 | 1.0 | 1.0 | 1.0 | 1.0 | 1.0 |
| (parts by mass) | | | | | | | | |

| | | | | | | | |
|---|---|---|---|---|---|---|---|
| Deflection temperature under load (DTUL (° C.)) | 200 | 200 | 200 | 200 | 200 | 200 | 200 |
| Continuous moldability (shot number at which clouding | >300 | 29 | >500 | >300 | >300 | >300 | >300 |
| started to occur on the mirror surface) | | | | | | | |
| Diffuse reflectance (% R), initial, 400 nm | 2.0 | 3.8 | 2.0 | 1.8 | 1.7(*1) | 1.2 | 1.1 |

(*1)Burr occurred at an acceptable level.

TABLE 2

| | | Example | Example | Comparative | Comparative | Example | Example | Comparative |
|---|---|---|---|---|---|---|---|---|
| | | 11 | 12 | Example 5 | Example 6 | 13 | 14 | Example 7 |
| Mold surface treatment | Diamond like carbon | Done | Done | Done | Done | Done | Done | Done |
| Molding conditions | Pressure keeping force (MPa) | 50 | 50 | 50 | 50 | 50 | 50 | 50 |
| | Pressure keeping speed (mm/s) | 50 | 50 | 50 | 50 | 50 | 50 | 50 |
| (A) Component | PPS resin A + PPS resin B | 100 | 100 | 100 | 100 | 100 | 100 | 100 |
| (parts by mass) | PPS resin C + PPS resin B | — | — | — | — | — | — | — |
| | PPS resin D + PPS resin B | — | — | — | — | — | — | — |
| (B) Component | Fibrous inorganic filler A | — | — | — | — | — | — | — |
| (parts by mass) | Whisker-like inorganic filler A | 51 | 51 | — | — | 51 | 38 | 26 |
| | Whisker-like inorganic filler B | 13 | 13 | — | 34 | 13 | 13 | 13 |
| (C) Component | Particulate filler A | — | — | 55 | — | 89 | 102 | 115 |
| (parts by mass) | Particulate filler B | — | — | — | — | — | — | — |
| | Particulate filler C | 89 | — | — | — | — | — | — |
| | Particulate filler D | — | 90 | — | — | — | — | — |
| (D) Component | Lubricant A | — | — | — | — | — | — | — |
| (parts by mass) | Lubricant B | 0.51 | 0.77 | 0.31 | 0.27 | — | 0.51 | 0.51 |
| | Lubricant C | — | — | — | — | 0.51 | — | — |
| (E) Component | Silane compound | 1.0 | 1.0 | 0.6 | 0.5 | 1.0 | 1.0 | 1.0 |
| (parts by mass) | | | | | | | | |

| | | | | | | | |
|---|---|---|---|---|---|---|---|
| Deflection temperature under load (DTUL (° C.)) | 201 | 203 | 131 | 223 | 202 | 201 | 197 |
| Continuous moldability (shot number at which clouding | >300 | >300 | >300 | 90 | >300 | >300 | >300 |
| started to occur on the mirror surface) | | | | | | | |
| Diffuse reflectance (% R), initial, 400 nm | 1.9 | 3.4 | 2.2 | 2.1 | 1.8 | 1.9 | 1.8 |

| | | Example | Example | Example | Example | Example | Example | Example | Example |
|---|---|---|---|---|---|---|---|---|---|
| | | 15 | 16 | 17 | 18 | 19 | 20 | 21 | 22 |
| Mold surface treatment | Diamond like carbon | Done | Done | Done | Done | Done | Done | Done | Done |
| Molding conditions | Pressure keeping force (MPa) | 50 | 50 | 50 | 50 | 50 | 70 | 70 | 70 |
| | Pressure keeping speed | 50 | 50 | 50 | 50 | 50 | 150 | 150 | 150 |
| | (mm/s) | | | | | | | | |
| (A) Component | PPS resin A + PPS resin B | 100 | 100 | — | — | — | — | — | — |
| (parts by mass) | PPS resin C + PPS resin B | — | — | 100 | 50 | — | 100 | 50 | — |
| | PPS resin D + PPS resin B | — | — | — | 50 | 100 | — | 50 | 100 |
| (B) Component | Fibrous inorganic filler A | — | — | — | — | — | — | — | — |
| (parts by mass) | Whisker-like inorganic | 51 | 38 | 51 | 51 | 51 | 51 | 51 | 51 |
| | filler A | | | | | | | | |
| | Whisker-like inorganic | 26 | 26 | 13 | 13 | 13 | 13 | 13 | 13 |
| | filler B | | | | | | | | |
| (C) Component | Particulate filler A | 77 | 89 | 89 | 89 | 89 | 89 | 89 | 89 |
| (parts by mass) | Particulate filler B | — | — | — | — | — | — | — | — |
| | Particulate filler C | — | — | — | — | — | — | — | — |
| | Particulate filler D | — | — | — | — | — | — | — | — |
| (D) Component | Lubricant A | — | — | — | — | — | — | — | — |
| (parts by mass) | Lubricant B | 0.51 | 0.51 | 0.51 | 0.51 | 0.51 | 0.51 | 0.51 | 0.51 |
| | Lubricant C | — | — | — | — | — | — | — | — |
| (E) Component | Silane compound | 1.0 | 1.0 | 1.0 | 1.0 | 1.0 | 1.0 | 1.0 | 1.0 |
| (parts by mass) | | | | | | | | | |

| | | | | | | | | |
|---|---|---|---|---|---|---|---|---|
| Deflection temperature under load (DTUL (° C.)) | 213 | 216 | 201 | 201 | 201 | 201 | 201 | 201 |
| Continuous moldability (shot number at which | >300 | >300 | >300 | >300 | >300 | >300 | >300 | >300 |
| clouding started to occur on the mirror surface) | | | | | | | | |
| Diffuse reflectance (% R), initial, 400 nm | 2.8 | 2.5 | 2.3 | 2.7 | 3.8 | 1.3 | 1.5 | 2.0 |

From Table 1, the following conclusions can be obtained.

In Example 1 corresponding to the first aspect of the present invention, good results were obtained for all of continuous moldability, heat resistance and surface properties (low diffuse reflectance). In contrast, Comparative Example 1 where the resin composition was almost identical to that in Example 1 except that the (C) component was not blended had poor surface properties. From this, it is apparent that in the first aspect, an excellent effect cannot be obtained in surface properties unless the (C) component is present. Comparative Example 2 different from Example 1 only in that molding was performed without using a mold in which a cavity surface is subjected to a surface treatment to be coated by a diamond-like carbon coating film had extremely poor continuous moldability.

In Examples 2 and 3 corresponding to the second aspect of the present invention, good results were obtained for all of continuous moldability, heat resistance and surface properties (low diffuse reflectance). In contrast, Comparative Example 3 where a whisker-like inorganic filler having a fiber length of 9 μm was blended in place of the (B2) component had poor heat resistance. From this, it is apparent that when a whisker-like inorganic filler having a single fiber length is used, heat resistance is deteriorated unless the fiber length is one specified in the second aspect. The mass fraction of each component to the whole composition in Example 3 and Comparative Example 6 is as follows: (A) component: 39.1% by mass, (B) component: 25% by mass, (C) component: 35% by mass, (D) component: 0.3% by mass and (E) component: 0.4% by mass in Example 3; and (A) component: 74.2% by mass, (B) component: 25% by mass, (C) component: 0% by mass, (D) component: 0.2% by mass and (E) component: 0.4% by mass in Comparative Example 6. That is, Comparative Example 6 is an example in which the (A) component in an amount almost equal to the amount of the (C) component is blended in place of the (C) component in Example 3. In other words, Comparative Example 6, where the resin composition was almost identical to that in Example 3 except that the (C) component was not blended, had poor continuous moldability. From this, it is apparent that in the second aspect, an excellent effect cannot be obtained in continuous moldability unless the (C) component is present.

Further, in Examples 4 to 22 corresponding to the third aspect of the present invention, good results were obtained for all of continuous moldability, heat resistance and surface properties (low diffuse reflectance). In contrast, Comparative Example 4 different from Example 5 only in that molding was performed without using a mold in which a cavity surface is subjected to a surface treatment to be coated by a diamond-like carbon coating film had extremely poor continuous moldability.

On the other hand, Examples 5, 6 and 13 had the same composition except for the (D) lubricant, and Example 6 using as the (D) lubricant a polyethylene wax having an acid value of 0 was superior in continuous moldability to Examples 5 and 13 that did not use the lubricant. From this, it is apparent that when use of a polyethylene wax having an acid value of 0 improves continuous moldability.

In each of Examples 7 to 10 where the pressure keeping force and the pressure keeping speed were increased as compared to example 6, surface properties are apparently improved. Particularly, the effect of improving surface properties (low diffuse reflectance) is remarkable when the pressure keeping speed is increased. Surface properties (low diffuse reflectance) are also improved when the pressure keeping force is increased, but when the pressure keeping force is 100 MPa, slight burr occurs (at an acceptable level), and therefore the pressure keeping force may be preferably about 70 MPa.

Further, from comparison among Examples 4, 6, 11 and 12 which have almost the same resin composition except for the (C) particulate filler, it is apparent that use of the (C) particulate filler having an average particle size 50% d of 1.5 μm or less improves surface properties (low diffuse reflectance) as compared to use of (C) particulate filler having an average particle size 50% d of more than 1.5 μm.

Further, from comparison among Examples 6 and 14 to 16, it is apparent that in the third aspect, surface properties (low diffuse reflectance) are improved when the mass ratio (X/Y) of the whisker-like inorganic filler A (B2a) (X parts by mass) having a fiber length of 2 μm or more and less than 30 μm and the whisker-like inorganic filler B (B2b) (Y parts by mass) having a fiber length of 100 μm or more and less than 1000 μm and a fiber diameter of 5 to 50 μm is about 3 to 4 rather than about 2.

1. A method for producing a light-reflecting component, the method comprising a step of injection-molding a resin composition obtained by melting and kneading a mixture containing 100 parts by mass of (A) a polyarylene sulfide resin, 10 to 120 parts by mass of (B 1) a fibrous inorganic filler having a fiber length of 1 to 5 mm and 10 to 220 parts by mass of (C) a particulate filler using a mold in which a cavity surface is subjected to a surface treatment to be coated by a diamond-like carbon coating film.

2. A method for producing a light-reflecting component, the method comprising a step of injection-molding a resin composition obtained by melting and kneading a mixture containing 100 parts by mass of (A) a polyarylene sulfide resin, 30 to 150 parts by mass of (B2) a whisker-like inorganic filler having a fiber length of 30 μm or more and less than 1000 μm and 10 to 220 parts by mass of (C) a particulate filler using a mold in which a cavity surface is subjected to a surface treatment to be coated by a diamond-like carbon coating film.

3. A method for producing a light-reflecting component, the method comprising a step of injection-molding a resin composition obtained by melting and kneading a mixture containing 100 parts by mass of (A) a polyarylene sulfide resin, X parts by mass of (BR2a) a whisker-like inorganic filler having a fiber length of 2 μm or more and less than 30 μm, Y parts by mass of (B2b) a whisker-like inorganic filler having a fiber length of 100 μm or more and less than 1000 μm and a fiber diameter of 5 to 50 μm and 10 to 220 parts by mass of (C) a particulate filler using a mold in which a cavity surface is subjected to a surface treatment to be coated by a diamond-like carbon coating film, the resin composition satisfying all of the following formulae (1) to (3):
4/3<X/Y≦4 formula (1)
13≦Y<30 formula (2)
50≦X+Y≦150 formula (3).

4. The method for producing a light-reflecting component according to claim 1, wherein the mixture is a mixture containing 100 parts by mass of (A) a polyarylene sulfide resin, 20 to 40 parts by mass of (B1) a fibrous inorganic filler having a fiber length of 1 to 3 mm and a fiber diameter of 3 to 7 μm and 10 to 220 parts by mass of (C) a particulate filler.

5. The method for producing a light-reflecting component according to claim 2, wherein the mixture is a mixture containing 100 parts by mass of (A) a polyarylene sulfide resin, 50 to 80 parts by mass of (B2) a whisker-like inorganic filler having a fiber length of 30 to 150 μm and a fiber diameter of 2 to 10 μm and 10 to 220 parts by mass of (C) a particulate filler.

6. The method for producing a light-reflecting component according to claim 3, wherein the mixture is a mixture containing 100 parts by mass of (A) a polyarylene sulfide resin, X parts by mass of (B2a) a whisker-like inorganic filler having a fiber length of 2 μm or more and less than 30 μm and a fiber diameter of 2 to 10 μm, Y parts by mass of (B2b) a whisker-like inorganic filler having a fiber length of 100 to 150 μm and a fiber diameter of 5 to 10 μm and 10 to 220 parts by mass of (C) a particulate filler, the resin composition satisfying all of the following formulae (1) to (3′):
4/3<X/Y≦4 formula (1)
13≦Y<30 formula (2)
50≦X+Y≦80 formula (3′).

7. The method for producing a light-reflecting component according to claim 1, wherein the mixture is a mixture further containing (D) a lubricant.

8. The method for producing a light-reflecting component according to claim 7, wherein a polyethylene wax having no acid value is used as the (D) lubricant.

9. The method for producing a light-reflecting component according to claim 5, wherein the mixture is a mixture which contains, as the (C) particulate filler, 50 to 110 parts by mass of a particulate filler having an average particle diameter (50% d) of 1.5 μm or less as measured by a laser diffraction/scattering method, and further contains 0.1 to 2 parts by mass of (D) a polyethylene wax having no acid value.

10. The method for producing a light-reflecting component according to claim 6, wherein the mixture is a mixture which contains, as the (C) particulate filler, 50 to 110 parts by mass of a particulate filler having an average particle diameter (50% d) of 1.5 μm or less as measured by a laser diffraction/scattering method, and further contains 0.1 to 2 parts by mass of (D) a polyethylene wax having no acid value.

11. The method for producing a light-reflecting component according to claim 1, wherein the mixture is a mixture further containing (E) a silane compound.

12. The method for producing a light-reflecting component according to claim 1, wherein the pressure keeping force during injection molding is 50 to 70 MPa.

13. The method for producing a light-reflecting component according to claim 1, wherein the pressure keeping speed during injection molding is 50 to 150 mm/sec.

14. A light-reflecting component produced by the method for producing a light-reflecting component according to claim 1.
